(19) United States
(12) Patent Application Publication
(10) Pub. No.: US 2014/0174882 A1
(43) Pub. Date: Jun. 26, 2014

(54) CLOSED LOOP TRANSPORTATION SYSTEM

(71) Applicant: Anwar M. Farooq, Montclair, CA (US)

(72) Inventor: Anwar M. Farooq, Montclair, CA (US)

(21) Appl. No.: 13/726,096

(22) Filed: Dec. 22, 2012

(51) Int. Cl. B66B 21/00

(52) U.S. Cl. CPC B66B 21/00
USPC 198/321

(57) ABSTRACT

A closed loop transportation system provides an automated system that transports users waiting in a queue from a loading point to an unloading point, while in a sitting position. The queue initiates at a loading point, follows various path shapes, and then terminates at an unloading point. The system includes a line portion for transporting the user in the queue. The line portion can move the queue through an underground chain link. A propulsion portion moves the line portion and the seat along the queue. A rotation portion redirects the line portion. At least one seat that joins with the line portion. A line rod extends from the line portion to secure with a seat rod that extends up from the seat. The seat detaches from the line portion for regulating the quantity of users. The seat includes wheels for facilitating movement along the line portion.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to queues. More particularly, the invention relates to automated closed loop queues.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a queue is where a line of people wait. The line of people may be considered the queue.

Typically, events where many people attend have an entry point and a final destination point. A checkpoint, such as a ticket counter may position in between. A queue may form an orderly advance of the people.

Typically, a chair is a raised surface used to sit on, commonly for use by one person. Chairs are most often supported by four legs and have a back. However, a chair can have three legs or could have a different shape.

In view of the foregoing, it is clear that these techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate a top view of an exemplary closed loop transportation system, in accordance with an embodiment of the present invention, where FIG. 1A illustrates a half serpentine pattern of an exemplary line portion, and FIG. 1B illustrates a full serpentine pattern of an exemplary line portion;

FIG. 2 illustrates a sectioned view of an exemplary closed loop transportation system, in accordance with an embodiment of the present invention;

FIG. 3 illustrates a frontal view of an exemplary at least one seat, in accordance with an embodiment of the present invention; and

FIG. 4 illustrates a detailed perspective view of an exemplary at least one seat, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of queuing transportation systems that may be provided by preferred embodiments of the present invention. In one embodiment of the present invention, a closed loop transportation system may provide an automated system that transports at least one user waiting in a queue from a loading point to an unloading point, while in a sitting position. In some embodiments, the closed loop transportation system may include a slow moving closed loop transporter. The transporter may be installed and utilized in various facilities, including, without limitation, malls, zoos, museums, downtowns, and airports. A plurality of users may load and unload from a queue in the system without stopping the system. In some embodiments, the queue may include a plurality of users simultaneously waiting their turn to load at a loading point, and sit on the moving queue until reaching an unloading point. In some embodiments, the closed loop transportation system may be utilized for events where the at least one user requires entry to the same unloading point. The queue may form to accommodate various events, including, without limitation, an amusement park, a parking lot, a voting booth, a bank, and a sporting event. In this manner, an orderly line may form, and chaos or injury may be prevented. In some embodiments, the queue may follow a linear path. However, in other embodiments, the queue may follow various path shapes including, without limitation, a zigzag, a curve, a serpentine line, and a zigzag pattern. In yet another embodiment, the at least one user may obtain a number for synchronizing the order in the queue.

In one embodiment of the present invention, the closed loop transportation system may provide a line portion for transporting the at least one user waiting in the queue. The line portion may include various mechanisms for moving the queue, including, without limitation, a conveyor, a chain link, a steel cable, and a belt. In one embodiment, the line portion positions beneath the ground. In some embodiments, the line portion may include a closed loop that moves sufficiently slowly for the at least one user to load and unload. The line portion may include at least one seat. The at least one seat may include a raised surface configured for sitting on, including, without limitation, a chair, a bench, a stool, and a sofa. Those skilled in the art, in light of the present teachings will recognize that queues may require extensive standing for long periods of time. Elderly users, sick users, and infants may have physical limitations that necessitate sitting down after a short period. The at least one seat may provide relief while waiting in the queue. In some embodiments, the line portion may extend along the queue and engage the at least one seat to advance the at least one seat along the longitudinal axis of the queue from the loading end to the unloading end, and then returning back to the loading end. The line portion may position under a ground surface of the queue. In some embodiments, the line portion may be operable to force, pull, push, or attract the at least one seat along the longitudinal axis of the queue. In some embodiments, a line rod may extend upwardly from the line portion. The line rod may be configured to join with the at least one seat. A rear area of the at least one seat may include a seat rod that extends downwardly and joins with the line rod. The seat rod may include a cavity that allows the line rod to at least partially enter for a secure attachment. In some embodiments, the at least one seat may detach from the line portion. In this manner, the number of users waiting in the queue may be regulated by adding or removing seats from the closed loop transportation system as required. In some embodiments, the at least one seat may include at least one wheel for facilitating movement along the queue, whereby the at least one wheel may roll in a substantially parallel path with the line portion. However in another embodiment, the at least one wheel may not be utilized, but rather an angled rod may join a front area of the at least one seat with the line rod. In some embodiments, a propulsion portion may move the line portion along the queue. The propulsion portion may include, without limitation, a motor, a turnstile, and a magnet. In some embodiments, at least one rotation portion may engage the line portion. Each rotation portion may be disposed to position at points along the queue that diverge from a linear path. An operator may regulate the closed loop transportation system including, without limitation, actuation, speed, and number of seats. In yet another embodiment, the seat may join the line portion through welding. In yet another embodiment, the seat may join with housing around the line portion, including, without limitation, a chain, a magnet, an adhesive, and a fastener.

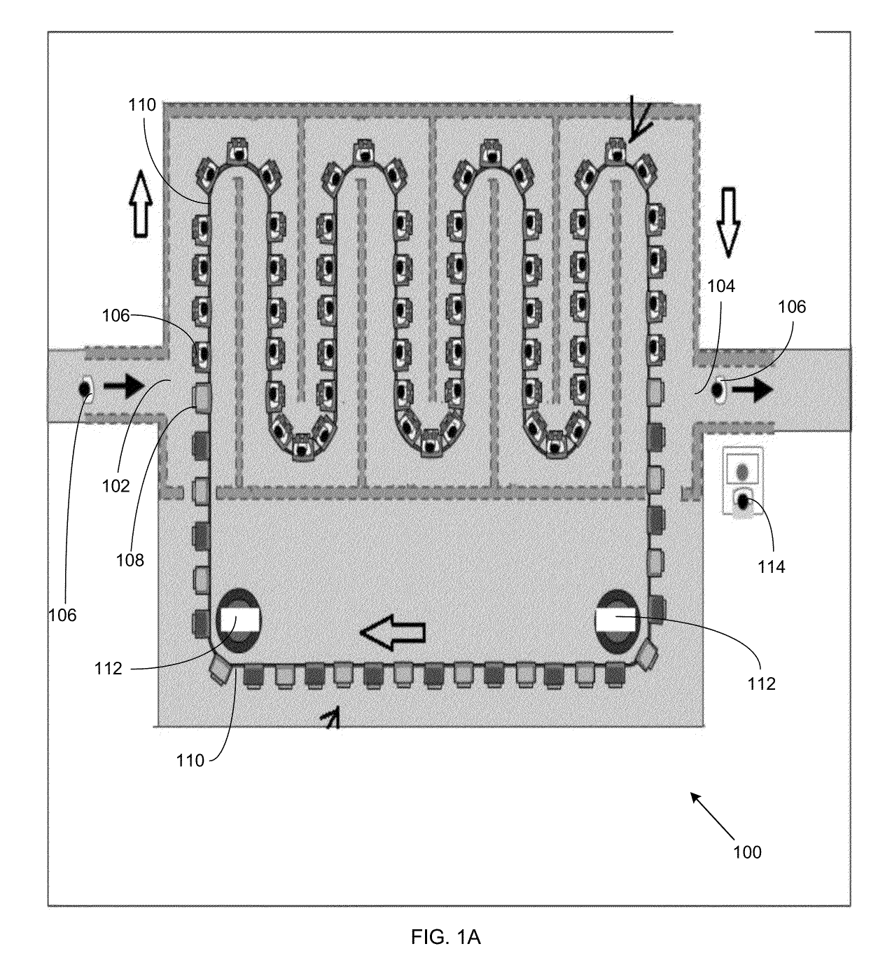

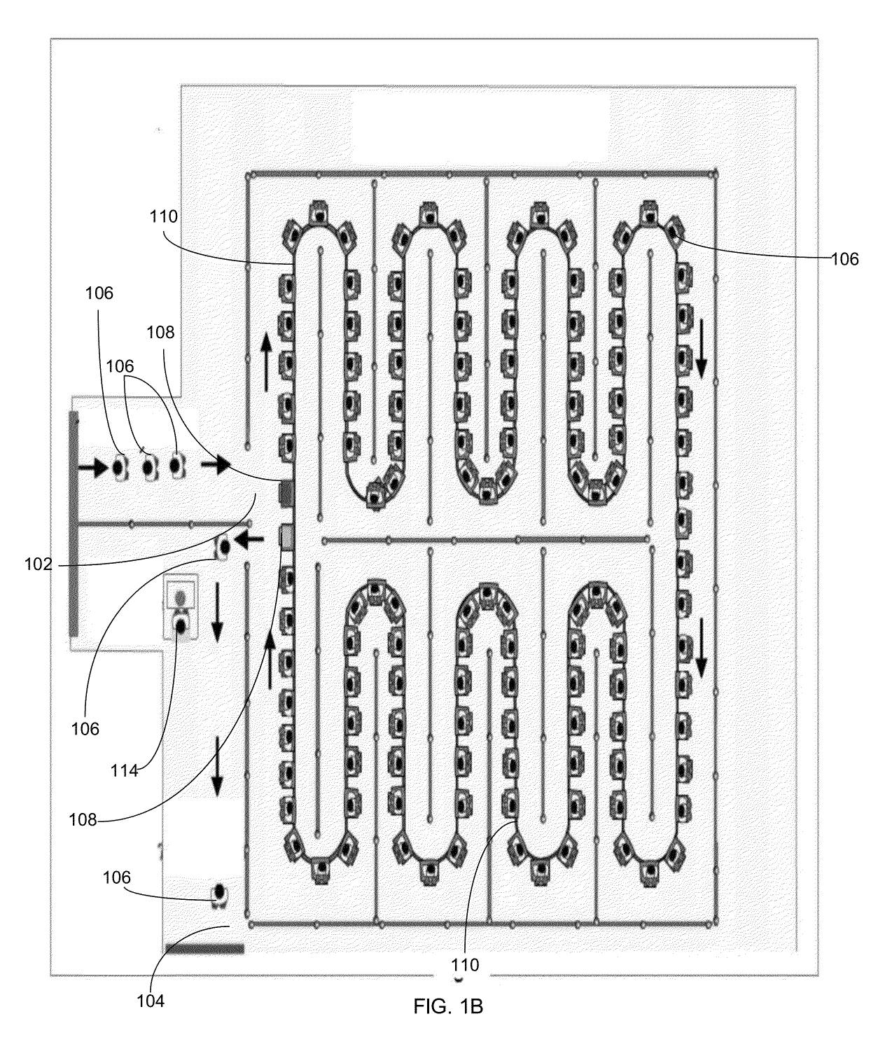

FIGS. 1A and 1B illustrate a top view of an exemplary closed loop transportation system, in accordance with an embodiment of the present invention, where FIG. 1A illustrates a half serpentine pattern of an exemplary line portion, and FIG. 1B illustrates a full serpentine pattern of an exemplary line portion. In the present invention, the closed loop transportation system 100 may provide an automated system that transports at least one user 106 waiting in a queue from a loading point 102 to an unloading point 104 while in a sitting position. However in other embodiments, the at least one user may utilize the closed loop transportation system in other positions, including, without limitation, leaning on a pole, lying down, or resting on a knee or standing temporarily on a foot rest. In some embodiments, the queue may include a plurality of users simultaneously waiting their turn to reach the unloading point. The systematic, closed loop nature of the closed loop transportation system may provide a more controlled queuing system. In some embodiments, the closed loop transportation system may be utilized for events where the at least one user requires entry to the same unloading point. The queue may form to accommodate various events, including, without limitation, an amusement park, a voting booth, shopping malls, airport, a bank, and a sporting event. In this manner, an orderly line may form at crowded events, and chaos or injury may be prevented. In some embodiments, the queue may follow a linear path. However, in other embodiments, the queue may follow various path shapes including, without limitation, a zigzag, a curve, a serpentine pattern, and a zigzag pattern. In one alternative embodiment, the closed loop transportation system may include an elevation that transports the at least one user to additional levels of a building. In one alternative embodiment, the closed loop transportation system may be configured to support an equitable amount of users, both waiting in the queue and prior to loading.

In one embodiment of the present invention, the closed loop transportation system may provide a line portion 110 for transporting the user waiting in the queue. The line portion may include various mechanisms for moving the queue, including, without limitation, a conveyor, a chain link, a steel cable, and a belt. In one embodiment, the line portion positions beneath the ground. In some embodiments, the line portion may include a closed loop that moves sufficiently slowly for the at least one user to load and unload. The line portion may be powered by various means, including, without limitation, electricity, magnets, and elasticity. The line portion may include at least one seat 108 for the at least one user to sit in while waiting in the queue. The seat may include a raised surface configured for sitting on, including, without limitation, a chair, a bench, a stool, and a sofa. Those skilled in the art, in light of the present teachings will recognize that queues may require extensive standing for long periods of time. Elderly users, sick users, and infants may have physical limitations that necessitate sitting down after a short period. The at least one seat may provide relief while waiting in the queue.

In one embodiment of the present invention, the line portion may extend along the queue and engage the at least one seat to advance the at least one seat along the longitudinal axis of the queue from the loading end to the unloading end, and then returning back to the loading end. However in other embodiments, the line portion may traverse in only one direction. The line portion may position under a ground surface of the queue. In one alternative embodiment, the line portion may extend from a ceiling and join with the at least one seat. In some embodiments, the line portion may include, without limitation, a chain, a steel cable, a belt, a rope, and a wire. The line portion may be operable to pull, push, or attract the at least one seat along the longitudinal axis of the queue. In some embodiments, a line rod may extend upwardly from the line portion. The line rod may be configured to join with the at least one seat. A rear area of the at least one seat may include a seat rod that extends downwardly and joins with the line rod. In some embodiments, the seat rod may include a cavity that allows the line rod to at least partially enter for a secure attachment. However in another embodiment, the line portion and the at least on seat may join through other mechanisms, including, without limitation, a magnet, a screw, a rope, and welding. In some embodiments, the at least one seat may detach from the line portion. In this manner, the number of users waiting in the queue may be regulated by adding or removing seats from the closed loop transportation system as required. In one alternative embodiment, the at least one seat may be configured so that some users stand while other users sit while waiting in the queue. In some embodiments, the at least one seat may include at least one wheel for facilitating movement along the queue, whereby the at least one wheel may roll in a parallel path with the line portion. However in another embodiment, the at least one wheel may not be utilized, but rather an angled rod may join a front area of the at least one seat with the seat rod. In yet another embodiment, a lower support portion may position between support members of the at least one seat. The lower support portion may be efficacious for providing a more comfortable wait in the queue. The lower support portion may include, without limitation, a foot rest that extends outwardly from the at least one seat and a support pole that extends from the ground surface. Those skilled in the art, in light of the present teachings, will recognize that a hollow tube may provide sufficient sturdiness for the seat rod. However, two or more seat rods may be necessary for additional strength due to heavy loads or excessive speeds. In some embodiments, a propulsion portion 112 may power the line portion through a gear portion. In this manner, various speeds and power may be utilized to convey the plurality of users. The propulsion portion may include, without limitation, a motor, a turnstile, and a magnet. In some embodiments, at least one rotation portion may engage and redirect the direction of the line portion. Each rotation portion may be disposed to position at points along the queue that diverge from a linear path. In some embodiments, an operator 114 may regulate the closed loop transportation system including, without limitation, actuation, speed, and number of seats. The operator may utilize a clutch and a speed regulator to control the closed loop transportation system. The clutch may release or hold the line portion as desired. The speed regulator may regulate the speed and torque of the line portion, as the operator desires. In some embodiments, the operator may be positioned along the queue so that the plurality of users is visible. In one alternative embodiment, the operator may be located in a remote location and monitor the queue through video cameras.

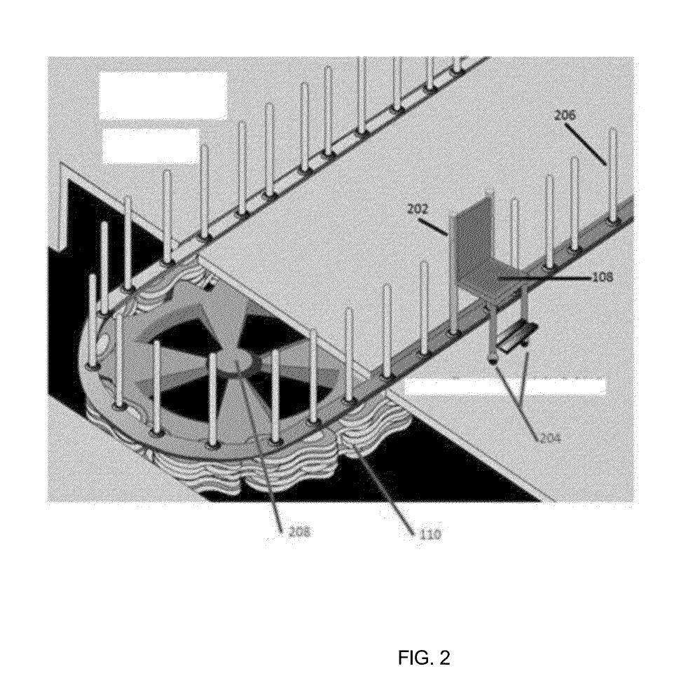

FIG. 2 illustrates a sectioned view of an exemplary closed loop transportation system, in accordance with an embodiment of the present invention. In the present invention, the at least one seat may join with the line portion through rods. In some embodiments, a seat rod 202 may include a hollow tube that extends upwardly from a rear portion of each seat. The line rod 206 may extend from the line portion, and thereby at least partially enter the seat rod. In one alternative embodiment, the seat rod and the line rod may securely join though various means, including, without limitation, a magnet, an adhesive, and a fastener. As the line portion advances the at least one seat along the longitudinal axis of the queue, a rotation portion 208 may provide a point of reference and stability to the conveyer. The rotation portion may engage the line portion so that the line portion deviates from a linear path, including, without limitation, a 180 degree turn, a wavy path, and a 90 degree angle. In some embodiments, the at least one seat may include at least one wheel 204 for facilitating movement along the queue, whereby the at least one wheel may roll in a parallel path with the line portion. However in one alternative embodiment, the at least one seat may traverse along the queue through various mechanisms, including, without limitation, a track, a slot, and a magnetic field. In one embodiment, whenever the turn comes for twenty of the users to load on the closed loop transportation system, the operator may actuate the closed loop transportation system and all the seats may advance one seating space for one user to unload.

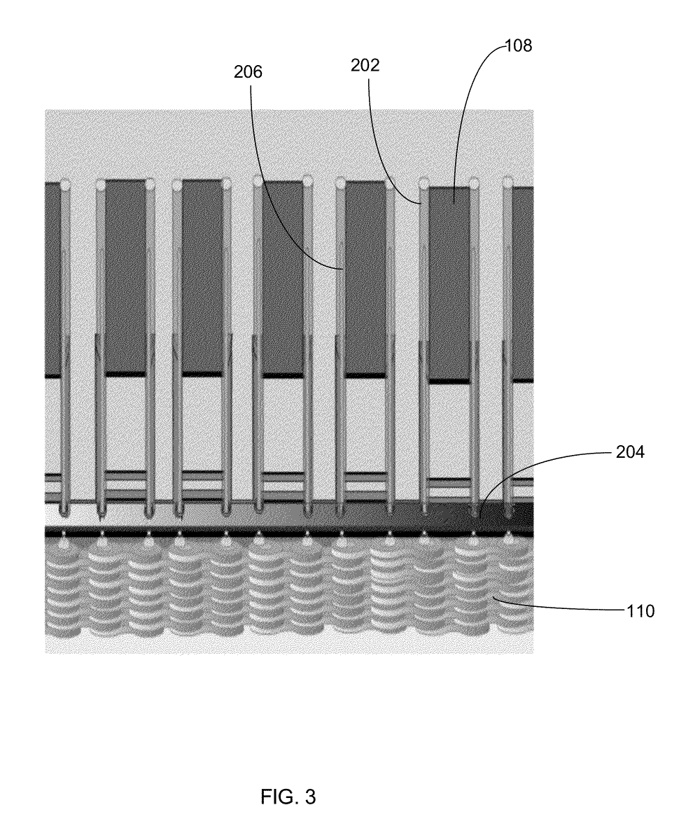

FIG. 3 illustrates a frontal view of an exemplary at least one seat, in accordance with an embodiment of the present invention. In the present invention, the at least one seat may detach from the line portion. In this manner, the number of users waiting in the queue may be regulated by adding or removing seats from the closed loop transportation system as required. In one alternative embodiment, the at least one seat may be configured so that some users stand while other users sit while waiting in the queue. In some embodiments, the at least one seat may include at least one wheel for facilitating movement along the queue, whereby the at least one wheel may roll in a parallel path with the line portion. However in another embodiment, the at least one wheel may not be utilized, but rather an angled rod may join a front area of the at least one seat with the seat rod. In some embodiments, the line rod may position inside the hollow seat rod.

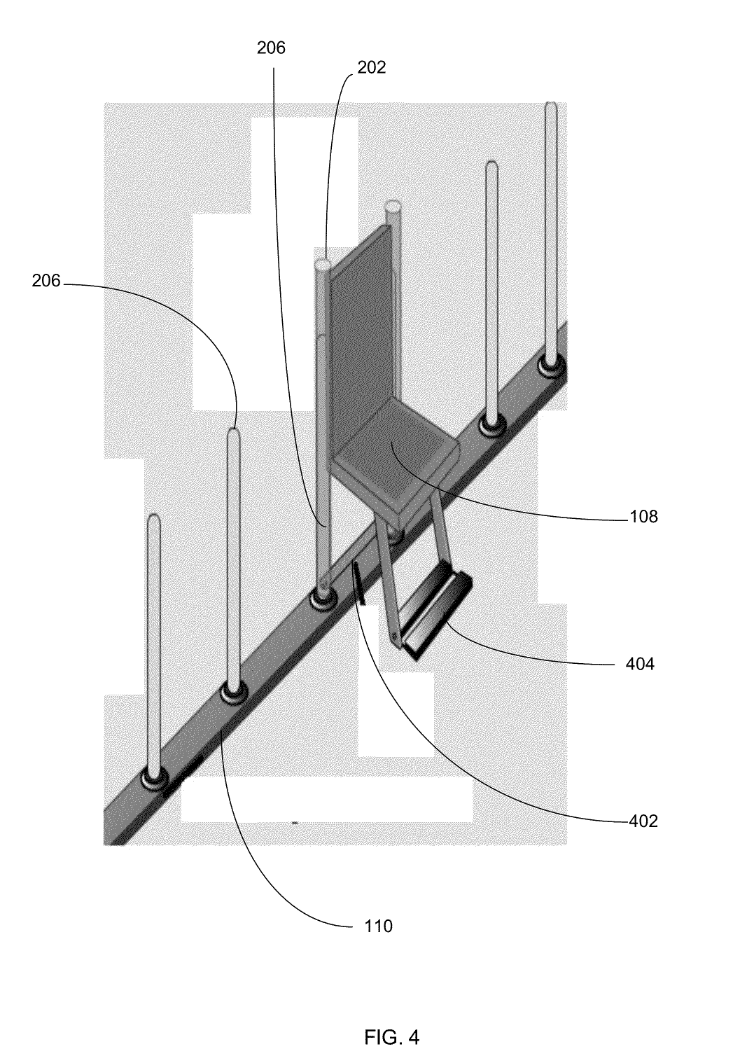

FIG. 4 illustrates a detailed perspective view of an exemplary at least one seat joined with a footboard, in accordance with an embodiment of the present invention. In the present invention, the at least one seat may allow the plurality of users additional comfort while waiting in the queue. In one alternative embodiment, the closed loop transportation system may include at least one table for the plurality of users to rest objects on while waiting in the queue. In yet another alternative embodiment, the at least one seat may vibrate to provide a massage to the plurality of users. However in another embodiment, the at least one wheel may not be utilized, but rather an angled rod 402 may join a front area of the at least one seat with the seat rod. In yet another embodiment, a lower support portion 404 may position between support members of the at least one seat. The lower support portion may be efficacious for providing a more comfortable wait in the queue. The lower support portion may include, without limitation, a foot rest that extends outwardly from the at least one seat and a support pole that extends from the ground surface. In yet another alternative embodiment, the closed loop transportation system may include entertainment for the plurality of users while sitting, including, without limitation, computer monitor, television, video games, music, and snacks. In yet another alternative embodiment, the line portion may move submerged in a liquid, including, without limitation a pond, an aquarium, and a sea. For example, without limitation, the plurality of users may board an underwater theme based ride at an amusement park that utilizes the closed loop transportation system through a themed attraction, or between various attractions.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing a closed loop transportation system according to the present invention will be apparent to those skilled in the art. Various aspects of the invention have been described above by way of illustration, and the specific embodiments disclosed are not intended to limit the invention to the particular forms disclosed. The particular implementation of the queuing system may vary depending upon the particular context or application. By way of example, and not limitation, the closed loop transportation system described in the foregoing were principally directed to seats positioned on an automated queuing system implementations; however, similar techniques may instead be applied to transporting vehicles on a highway, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

1. A system comprising:
a line portion, in which said line portion comprising a loading point, wherein said loading point being disposed to initiate said line portion, in which said line portion further comprising an unloading point, wherein said unloading point being disposed to terminate said line portion, in which said line portion further comprising a line rod, wherein said line rod being disposed to extend from said line portion;
a propulsion portion, wherein said propulsion portion being operable to propel said line portion; and
at least one seat, wherein said at least one seat being configured to support at least one user, in which said at least one seat comprising a seat rod, wherein said seat rod being configured to join with said line rod, and wherein said at least one seat being disposed to move in a substantially parallel path to said line portion, in which said at least one seat comprises an angled rod.

2. The system of claim 1, in which said line portion comprises a queue.

3. The system of claim 1, wherein said line portion is operable to move in a closed loop continuous motion transporter.

4. The system of claim 1, wherein said line portion is disposed to follow a nonlinear path, said nonlinear path comprising a serpentine pattern.

5. The system of claim 1, wherein said line portion is operable to move to a higher elevation and a lower elevation.

6. The system of claim 1, in which said line portion comprises a chain link.

7. The system of claim 1, in which said line portion comprises a clutch.

8. The system of claim 7, in wherein said clutch is operable to engage and disengage said at least one seat from said line portion.

9. The system of claim 1, in which said propulsion portion comprises a motor.

10. The system of claim 1, in which said propulsion portion comprises at least one rotation portion.

11. The system of claim 10, in which said at least one rotation portion is configured to engage said line portion.

12. The system of claim 1, in which said angled rod is at least one wheel.

13. The system of claim 12, wherein said at least one wheel is operable to at least partially facilitate movement of said at least one seat along said line portion.

14. (canceled)

15. The system of claim 1, wherein said angled rod is configured to join said at least one seat with said line rod.

16. The system of claim 1, in which said at least one seat comprises a lower support portion.

17. The system of claim 16, in which said lower support portion comprises a foot rest.

18. The system of claim 1, in which said system comprises an operator, said operator being operable to regulate a velocity and direction of said line portion.

19. A system comprising:
means for initiating a queue at a loading point;
means for joining said initiating means to at least one seat, in which said joining means further comprise of a connecting means for connecting said at least one seat with said joining means.
means for positioning said at least one user on said at least one seat;
means for moving initiating means; and
means for terminating said queue at an unloading point.

20. A system consisting of:
a line portion, in which said line portion comprising a queue, said line portion further comprising a loading point, wherein said loading point being disposed to initiate said line portion, in which said line portion further comprising an unloading point, wherein said unloading point being disposed to terminate said line portion, wherein said line portion further being disposed to follow a substantially nonlinear path, in which said line portion further comprising a chain link, said line portion further comprising a line rod, and wherein said line rod being disposed to extend from said line portion;
a propulsion portion, wherein said propulsion portion being operable to move said line portion, in which said propulsion portion comprising a motor, and in which said propulsion portion further comprising at least one rotation portion, wherein said at least one rotation portion being configured to engage said line portion, and wherein said rotation portion being operable to alter a direction of said line portion; and
at least one seat, wherein said at least one seat being configured to support at least one user, in which said at least one seat comprising a seat rod, wherein said seat rod being configured to join with said line rod, and wherein said at least one seat being disposed to move in a substantially parallel path to said line portion, in which said at least one seat further comprising an angled rod, wherein said angled rod being configured to join said line portion with said at least one seat, in which said at least one seat further comprising a lower support portion, wherein said lower support portion comprising a foot rest, and in which said at least one seat further comprising at least one wheel.
